(19) United States
(12) Patent Application Publication
(10) Pub. No.: US 2007/0211875 A1
(43) Pub. Date: Sep. 13, 2007

(54) Method of controlling an electronic device using audio inputs

(75) Inventor: Mikko Nurmi, Tampere (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/371,129

(22) Filed: Mar. 7, 2006

(51) Int. Cl. H04M 3/42

(52) U.S. Cl. 379/201.01

(57) ABSTRACT

A method of controlling an electronic device, during a voice call, using audio inputs, the method including detecting a first interrupt during the voice call while audio input control is disabled; controlling the electronic device, in response to detection of the first interrupt, to prevent the inclusion of audio inputs within the voice call and to enable audio input control of the electronic device; and controlling the electronic device in response to detection of a second subsequent interrupt, to disable the audio input control and to re-enable the inclusion of audio inputs within the voice call.

### FIELD OF THE INVENTION

Embodiments of the present invention relate to a method of controlling an electronic device using audio inputs. In particular, they relate to a method of controlling an electronic device such as a telephone using audio inputs during a voice call.

### BACKGROUND TO THE INVENTION

When a user is using a telephone to make a voice call they often need to access other functions of the telephone, for example they may wish to adjust the volume of the telephone or access data stored in the telephone. General methods of accessing the functions of a telephone involve using a graphical user interface. This is an inconvenient way of accessing functions during a voice call as the user of the telephone has to remove the telephone away from their ear so that they can see the graphical user interface. It would be advantageous to provide an improved method of controlling a telephone during a voice call.

### BRIEF DESCRIPTION OF THE INVENTION

According to one embodiment of the invention there is provided a method of controlling an electronic device, during a voice call, using audio inputs, the method comprising: detecting a first interrupt during the voice call while audio input control is disabled; controlling the electronic device, in response to detection of the first interrupt, to prevent the inclusion of audio inputs within the voice call and to enable audio input control of the electronic device; and controlling the electronic device in response to detection of a second subsequent interrupt, to disable the audio input control and to re-enable the inclusion of audio inputs within the voice call.

This provides the advantage that when a voice call is in place the user can control the electronic device using audio inputs without interrupting the voice call. This allows the user to control the device without using a graphical user interface.

According to another embodiment of the invention there is provided an electronic device comprising: user input means comprising audio input means; and control means for controlling the electronic device, wherein the control means are arranged, in response to the detection of a first interrupt during a voice call while audio input control is disabled, to prevent the inclusion of audio inputs within the voice call and to enable audio input control of the electronic device and are arranged, in response to detection of a second subsequent interrupt, to disable the audio input control and re-enable the inclusion of audio inputs within the voice call.

According to another embodiment of the invention there is provided a computer program comprising program instructions for controlling an electronic device, controllable using audio inputs, which, when loaded into a processor provide; means for detecting, while audio input control is disabled, a first interrupt during a voice call; means for controlling the electronic device, in response to the detection of the first interrupt, to prevent the inclusion of audio inputs within the voice call and to enable audio input control of the electronic device; and means for controlling the electronic device, in response to the detection of a second interrupt, to disable the audio input control and to re-enable the inclusion of audio inputs within the voice call.

### BRIEF DESCRIPTION OF THE DRAWINGS

For a better understanding of the present invention reference will now be made by way of example only to the accompanying drawings in which:

FIG. 1 schematically illustrates an electronic device;

FIG. 2 illustrates a flow chart showing the method steps of an embodiment of the present invention;

### DETAILED DESCRIPTION OF EMBODIMENTS OF THE INVENTION

The Figures illustrate a method of controlling an electronic device 1, during a voice call, using audio inputs, the method comprising: detecting a first interrupt during the voice call while audio input control is disabled; controlling the electronic device 1, in response to detection of the first interrupt, to prevent the inclusion of audio inputs within the voice call and to enable audio input control of the electronic device 1; and controlling the electronic device 1 in response to detection of a second subsequent interrupt, to disable the audio input control and to re-enable the inclusion of audio inputs within the voice call.

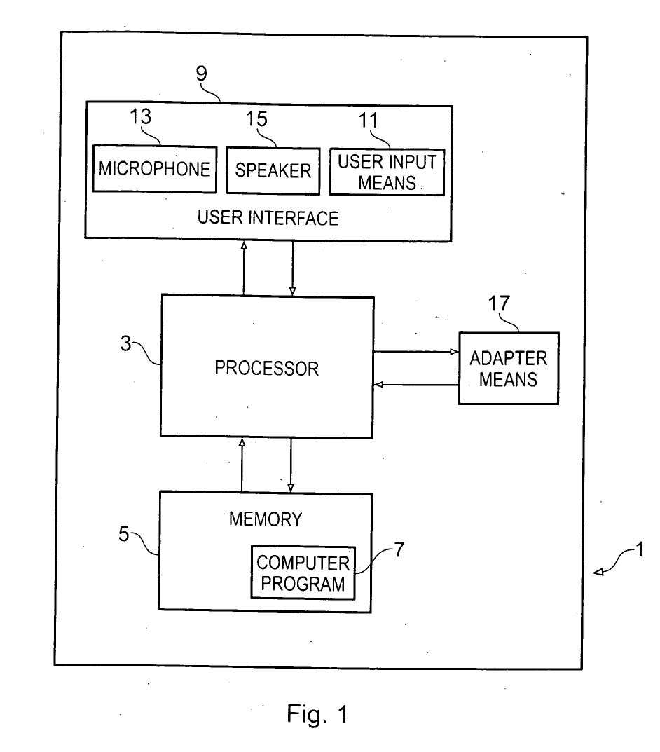

FIG. 1 schematically illustrates an electronic device 1 according to the present invention. Only the features referred to in the following description are illustrated. It should, however, be understood that the electronic device 1 may comprise additional features that are not illustrated.

The electronic device 1 may be any electronic device which allows a user to participate in a voice call. For example, the electronic device 1 may be a telephone which may be operable to communicate in a wired network or a portable radio telephone operable to communicate in a cellular network. The electronic device 1 may also be operable as, for example, a personal computer or a personal digital assistant.

The electronic device 1 illustrated comprises: a user interface 9, a memory 5, a processor 3 and adapter means 17.

The user interface 9 comprises user input means 11, a microphone 13 and a speaker 15. The user input means 11 may be any means which allow a user to input information into the electronic device 1 including, for example, a key pad, a joystick or a touch sensitive region of a display. The user input means 13 also comprise audio input means which enable a user to make audio inputs into the microphone 13 which can be used to control the electronic device 1.

The microphone 13 converts an audio input from the user into an electrical signal which can be transmitted to the processor 3. The processor 3 can then process the electrical signal either for transmission as part of a voice call or for recognition as a voice command. The speaker 15 is used to convert electrical signals from the processor 3 or the adapter means 17 into audio outputs. The audio outputs may be part of a voice call or outputs generated by the electronic device 1.

The processor 3 is connected to receive input commands from the user input means 11. The processor 3 is also connected to write to and read from the memory 5.

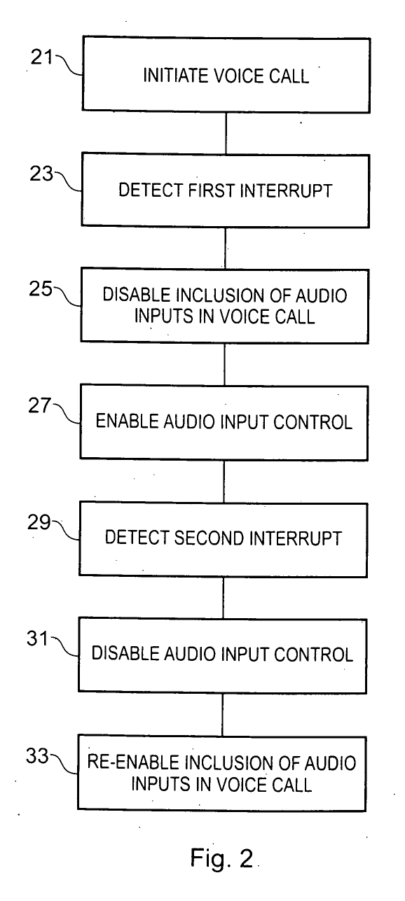

The memory 5 stores computer program instructions 7, which when loaded into the processor 3, enable the processor 3 to control the operation of the electronic device 1 as described below. The computer program instructions 7 provide the logic and routines that enables the electronic device 1 to perform the method illustrated in FIG. 2.

The computer program instructions 7 may arrive at the electronic device 1 via an electromagnetic carrier signal or be copied from a physical entity such as a computer program product, a memory device or a record medium such as a CD-ROM or DVD.

The adapter means 17 provide a connection to a network. The network may be a circuit switched network using the POTS or GSM, for example, or a packet switched network using VOIP or WCDMA, for example.

The adapter means 17 may be a transceiver which enables signals to be sent by and received by the electronic device 1 thereby allowing the electronic device 1 to participate in voice calls. For example, in the embodiment where the electronic device 1 is a portable radio telephone the adapter means 17 may be an antenna which allows the telephone to receive and transmit signals within cellular networks.

The adapter means 17 may be controlled by the processor 3. The processor 3 may process the electronic signals from the microphone 15 before they are transmitted by the adapter means 17. Signals received by the adapter means 17 may also be processed by the processor 3 before they are input to the speaker 15.

A method of controlling the electronic device 1, according to the present invention, is illustrated schematically in FIG. 2.

At step 21 the user of the electronic device 1 is participating in a voice call. The user makes audio inputs into the microphone 13 which are converted into an electronic signal and transmitted via the adapter means 17 to the other participants in the voice call.

The voice call may be between just two participants or it may be a conference call between a plurality of participants. The user of the electronic device 1 may initiate the voice call by dialing a number using the input means 11 or by answering an incoming call.

At step 23, the voice call is still ongoing and the processor 3 detects a first interrupt. The first interrupt may be generated by a user, for example, the first interrupt may be actuation of the user input means 11 such as a press of a key, or a press and hold of a key. The first interrupt may also be generated by the electronic device 1 or be received by the electronic device 1. For example the first interrupt may be an incoming call or a message or an interrupt provided by another participant in the voice call.

In response to the first interrupt, the processor 3 disables, at step 25, the inclusion of audio inputs in the voice call. The processor 3 controls the electronic device 1 so that the electronic signals from the microphone 13 are not sent to the adapter means 17.

At step 27, the processor 3 enables audio input control of the electronic device 1. The electronic signals from the microphone 13 are processed by the processor 3 to recognize a voice command in the audio input and determine the function associated with the voice command. The processor 3 may use an algorithm to recognize the voice command. Once the audio input has been recognized the processor 3 controls the electronic device 1 to carry out the function associated with the voice command.

When audio input control is enabled the device may also be operable to generate audio outputs. For example, if the first interrupt was the detection of an incoming call then the electronic device would disable the inclusion of audio inputs in the voice call and generate an audio output message to ask the user whether or not they wish to accept the incoming call.

According to one embodiment, when audio input control is enabled, the adapter means 17 will still be operable to receive incoming signals and the processor 3 will still be operable to transmit these signals to the speaker 15 so that the user of the electronic device can still hear the other participants of the voice call.

At step 29 the processor detects a second interrupt. The second interrupt may also be generated by a user. For example the second interrupt may be a second actuation of a user input, for example, a second press of a key or the release of a key which has been held down or an audio input voice command. Alternatively the second interrupt may be generated by the electronic device 1. For example the second interrupt may be generated upon the detection of a voice command or upon the completion of a task, which may have been initiated by a voice command. The second interrupt may also be the detection, by the processor 3, that no user input has occurred for a predetermined time. Alternatively the second interrupt may be received by the electronic device 1.

In response to the second interrupt the processor 3 controls the electronic device 1 to disable, at step 31, audio input control and re-enable, at step 33, the inclusion of audio inputs within the voice call so that the electronic signals from the microphone 13 are no longer processed for voice recognition but are sent to the adapter means 17 for inclusion in the voice call.

The electronic device 1 may make an audio output to alert the user that audio input control has been disabled and audio inputs are being included in the voice call again.

In some embodiments the electronic device 1 may also provide an alert to inform other participants in the voice call that the user of electronic device 1 is unable to transmit voice signals. For example, when audio input control is activated, the electronic device 1 may generate a signal which can be sent to other participants in the voice call. The signal may then be used to generate an alert such as an audio or a visual alert.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method of controlling an electronic device, during a voice call, using audio inputs, the method comprising:
detecting a first interrupt during the voice call while audio input control is disabled;
controlling the electronic device, in response to detection of the first interrupt, to prevent the inclusion of audio inputs within the voice call and to enable audio input control of the electronic device; and
controlling the electronic device in response to detection of a second subsequent interrupt, to disable the audio input control and to re-enable the inclusion of audio inputs within the voice call.

2. A method as claimed in claim 1 wherein the first interrupt is an actuation of a user input means.

3. A method as claimed in claim 1 wherein the second interrupt is an actuation of a user input means.

4. A method as claimed in claim 1 wherein the second interrupt is an audio input.

5. A method as claimed in claim 1 wherein the second interrupt is the completion of a task initiated by an audio input.

6. A method as claimed in claim 1 wherein the second interrupt is the detection that no user input has occurred for a predetermined time.

7. A method as claimed in claim 1 wherein, while the inclusion of audio inputs within the voice call is prevented, the electronic device is still operable to provide audio outputs.

8. A method as claimed in claim 7 wherein the audio output is an incoming part of the voice call.

9. A method as claimed in claim 7 wherein the audio output is generated by the electronic device in response to an audio input.

10. A method as claimed in claim 1 wherein the electronic device is a portable radio telephone.

11. An electronic device comprising:
user input means comprising audio input means; and
control means for controlling the electronic device,
wherein the control means are arranged, in response to the detection of a first interrupt during a voice call while audio input control is disabled, to prevent the inclusion of audio inputs within the voice call and to enable audio input control of the electronic device and are arranged, in response to detection of a second subsequent interrupt, to disable the audio input control and re-enable the inclusion of audio inputs within the voice call.

12. An electronic device as claimed in claim 11 wherein the first interrupt is an actuation of a user input means.

13. An electronic device as claimed in claim 11 wherein the second interrupt is an actuation of a user input means.

14. An electronic device as claimed in claim 11 wherein the second interrupt is an audio input.

15. An electronic device as claimed claim 11 wherein the second interrupt is the completion of a task initiated by an audio input.

16. An electronic device as claimed in claim 11 wherein the second interrupt is the detection that no input has occurred for a predetermined time.

17. An electronic device as claimed in claim 11 wherein, while the inclusion of audio inputs within the voice call is prevented, the electronic device is still operable to provide audio outputs.

18. An electronic device as claimed in claim 17 wherein the audio output is an incoming part of the voice call.

19. An electronic device as claimed in claim 17 wherein the audio output is generated by the electronic device in response to an audio input.

20. An electronic device as claimed in claim 11 wherein the electronic device is a portable radio telephone.

21. A computer program comprising program instructions for controlling an electronic device, controllable using audio inputs, which, when loaded into a processor provide;
means for detecting, while audio input control is disabled, a first interrupt during a voice call;
means for controlling the electronic device, in response to the detection of the first interrupt, to prevent the inclusion of audio inputs within the voice call and to enable audio input control of the electronic device; and
means for controlling the electronic device, in response to the detection of a second interrupt, to disable the audio input control and to re-enable the inclusion of audio inputs within the voice call.

22. A physical entity embodying the computer program as claimed in claim 21.

23. An electromagnetic carrier signal carrying the computer program as claimed in claim 21.

24. A computer program comprising program instructions for causing a computer to perform the method of claim 1.
